(19) United States
(12) Patent Application Publication
(10) Pub. No.: US 2022/0315381 A1
(43) Pub. Date: Oct. 6, 2022

(54) INTELLIGENT ELEVATOR CALL LOGIC

(71) Applicant: Otis Elevator Company, Farmington, CT (US)

(72) Inventor: Sandeep Sudi, Farmington, CT (US)

(21) Appl. No.: 17/221,092

(22) Filed: Apr. 2, 2021

(51) Int. Cl. B66B 1/46; B66B 1/28; B66B 3/00

(52) U.S. Cl. CPC B66B 1/468; B66B 1/28; B66B 3/002; B66B 2201/103; B66B 2201/4615; B66B 2201/463; B66B 2201/4676; B66B 2201/4684; B66B 2201/102; B66B 2201/4623

(57) ABSTRACT

Provided are embodiment for a method and a system for filtering unintended requests. The embodiments can include receiving an input to disable an elevator lock for an elevator car, and determining whether to unlock the elevator lock. The embodiments can also include unlocking the elevator lock based at least in part on the determination and permitting or prohibiting motion of the elevator car responsive to the determination.

### BACKGROUND

The present disclosure relates generally to elevator call management, and more specifically to intelligent elevator call logic for filtering unintended calls.

In today's environment, elevators can receive requests using a variety of techniques. For example, some elevator systems can input requests using a physical keypad while others can provide a request using kiosks or mobile applications. Traditionally, keypads are used to make floor selections and are accessible to any of the passengers that have entered the elevator car. The keypads are also made available to children who may intentionally or unintentionally place unwanted elevator call requests. Existing elevator systems may be limited in managing unwanted or nuisance elevator call requests. For example, elevators may not include any type of call filtering or lock-feature (i.e., child-lock) to prevent or reduce the unwanted selections.

### BRIEF SUMMARY

According to an embodiment, a method for filtering unintended elevator calls. The method includes receiving an input to disable an elevator lock for an elevator car; and determining whether to unlock the elevator lock. The method includes unlocking the elevator lock based at least in part on the determination; and responsive to the determination, permitting or prohibiting motion of the elevator car.

In addition to one or more of the features described herein, or as an alternative, further embodiments include filtering the input responsive to an incorrect input sequence from a panel.

In addition to one or more of the features described herein, or as an alternative, further embodiments include receiving an elevator call request indicating a floor selection for an elevator car responsive to unlocking the elevator lock, and dispatching the elevator car based at least in part on the floor selection.

In addition to one or more of the features described herein, or as an alternative, further embodiments include receiving the elevator call request within a period of time responsive to unlocking the elevator lock.

In addition to one or more of the features described herein, or as an alternative, further embodiments include enabling the elevator lock responsive to at least one of an elevator lock input or an expiration of a configurable period of time.

In addition to one or more of the features described herein, or as an alternative, further embodiments include an input that is received from a dedicated child-lock button, wherein the dedicated child-lock button is arranged above a panel for the elevator car.

In addition to one or more of the features described herein, or as an alternative, further embodiments include an input that has a predetermined sequence of buttons.

In addition to one or more of the features described herein, or as an alternative, further embodiments include an input that is received from an unlock mechanism, wherein the unlock mechanism is a switch.

In addition to one or more of the features described herein, or as an alternative, further embodiments include an input that is depressed for a configurable threshold period of time.

In addition to one or more of the features described herein, or as an alternative, further embodiments include providing an indication that the elevator car is unlocked.

According to another embodiment, a system for managing elevator call requests. The system includes a controller or device to control an elevator car, and a panel coupled to the controller, wherein the panel is configured to provide an input to the controller. The controller is configured to receive an input to unlock an elevator lock, and determine whether to unlock the elevator lock. The controller is also configured to unlock the elevator lock based at least in part on the determination, and permit or prohibit motion of the elevator car responsive to the determination.

In addition to one or more of the features described herein, or as an alternative, further embodiments include a controller that is configured to filter the input responsive to an incorrect input sequence from the panel.

In addition to one or more of the features described herein, or as an alternative, further embodiments include a elevator controller that is configured to receive an elevator call request indicating a floor selection for an elevator car responsive to unlocking the elevator lock; and dispatch the elevator car based at least in part on the floor selection.

In addition to one or more of the features described herein, or as an alternative, further embodiments include a controller that is configured to receive the elevator call request within a period of time responsive to unlocking the elevator lock.

In addition to one or more of the features described herein, or as an alternative, further embodiments include a controller that is configured to enable the elevator lock responsive to at least one of an elevator lock input or an expiration of a configurable period of time.

In addition to one or more of the features described herein, or as an alternative, further embodiments include an input that is received from a dedicated child-lock button, wherein the dedicated child-lock button is arranged above the panel for the elevator car.

In addition to one or more of the features described herein, or as an alternative, further embodiments include an input that has a predetermined sequence of buttons.

In addition to one or more of the features described herein, or as an alternative, further embodiments include an input that is received from a unlock mechanism, wherein the unlock mechanism is a switch.

In addition to one or more of the features described herein, or as an alternative, further embodiments include an input that is depressed for a configurable threshold period of time.

In addition to one or more of the features described herein, or as an alternative, further embodiments include a controller that is configured to provide an indication of the elevator being unlocked.

Technical effects of embodiments of the present disclosure include the efficient management of elevator call requests and filtering the unwanted elevator call requests.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIGS. 2A, 2B, and 2C depict schematic illustrations of various architectures for managing elevator call requests in accordance with one or more embodiments of the disclosure;

FIGS. 3A and 3B depict schematic illustrations of various architectures for managing hall call requests in accordance with one or more embodiments of the disclosure; and

FIG. 4 depicts a flowchart of a method for managing elevator call requests in accordance with one or more embodiments.

### DETAILED DESCRIPTION

The techniques of one or more embodiments described herein provide solutions for managing elevator call requests and hall call requests. For example, by requiring a user to disable a lock-feature such as by entering a pin code, activating a switch, button, or mechanism, to reduce or prevent the nuisance elevator call requests and hall call requests from being registered and serviced by the elevator system.

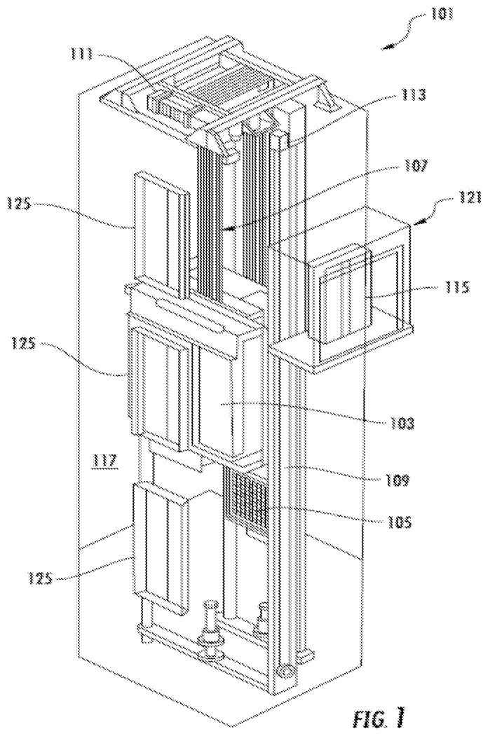

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, pinch wheels or traction wheels). FIG. 1 is merely a non-limiting example presented for illustrative and explanatory purposes.

In other embodiments, the system may include a conveyance system that moves passengers between floors and/or along a single floor. Such conveyance systems may include escalators, people movers, etc. Accordingly, embodiments described herein are not limited to elevator systems, such as that shown in FIG. 1.

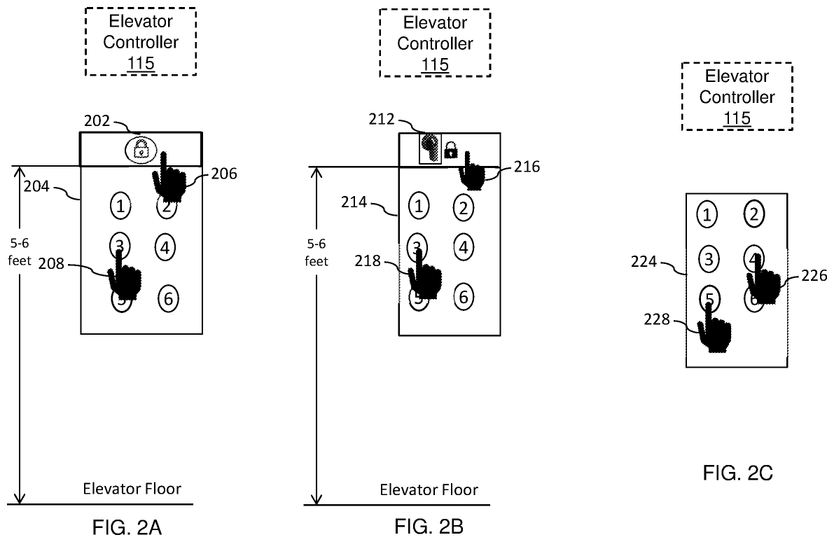

FIGS. 2A, 2B, and 2C depict various schematic illustrations of different architectures that can be used for managing elevator call requests in accordance with one or more embodiments of the disclosure. In one or more embodiments of the disclosure, the child-lock feature can be used to prevent the unwanted selection of elevator call requests. The default position of the child-lock is an enabled position which must be disabled to successful make a floor selection.

FIG. 2A includes incorporating an unlock button 202 (i.e., a child-lock button) into an elevator call panel 204 or input selection mechanism. In order to successfully register an elevator call request using the elevator call panel 204 with the elevator controller 115 (of FIG. 1) the unlock button 202 can be required to be initiated to disable the elevator lock. In a non-limiting example, the elevator lock does not allow elevator call requests to be registered to the elevator controller 115 until the elevator lock is disabled. The elevator call requests, prior to releasing the elevator lock, can be filtered or ignored by the elevator controller 115. In some embodiments, the unlock button 202 can be positioned at a height that may be unreachable for the average child height. For example, the unlock button 202 may be placed at a height of 5 feet, 5.5 feet, or 6 feet. It can be appreciated that the unlock button can be positioned at any height and should not be limited by the example described in the disclosure. Also, it can be appreciated that the unlock button 202 can be integrated into the elevator call panel 204 or it can be separate from the elevator call panel 204.

In other embodiments of the disclosure, the unlock button 202 may be implemented on a touch screen interface. In a different embodiment, the unlock button 202 may be a switch or other manual locking mechanism. In one or more embodiments, the control logic of the elevator controller 115 can require the unlock button 202 to be pressed for x seconds to unlock the elevator car 103, wherein x is an integer greater than 1.

When the elevator lock is disabled an indication can be provided on the elevator call panel 204 to notify the passengers the elevator car 103 has been unlocked and is ready to register an elevator call request. For example, one or more buttons may flash 2 or 3 times indicating the elevator care has been unlocked. Responsive to unlocking the elevator car 103, motion of the elevator car 103 is permitted to travel to a selected destination. In another example, an audible indication can be provided to the passengers. It can be appreciated that any other type of indication can be provided to notify the passengers that the elevator car 103 is either in the lock or unlocked state.

Responsive to actuating the unlock button 202, the elevator controller 115 can be configured with instructions to disable the elevator lock and allow a floor selection input to be registered using the elevator call panel 204. The elevator controller 115, operably coupled to the elevator call panel 204, is configured to receive the input for the floor selection.

As shown in the FIG. 2A, the control logic of the elevator controller 115 may require multiple inputs from the elevator unlock button 202 and another selection from the elevator call panel 204 as illustrated by the inputs 206 and 208. In a non-limiting example, the control logic may require multiple buttons to be simultaneously depressed. In another non-limiting example, the control logic can require a sequential input to be provided after the elevator lock is released. In other embodiments, the control logic may require that the inputs are pressed and held or pressed simultaneously with the desired floor selection.

FIG. 2B depicts a different embodiment for managing elevator call requests. As shown, the elevator call panel 214 includes an unlock switch 212. The switch 212 can include a spring-loaded mechanism to keep the elevator in the default position where the elevator lock is engaged. The switch 212 can be coupled to the elevator controller 115 and when the switch 212 is actuated, either by twisting, turning, or pressing, the elevator lock may be released to allow an elevator call request to be registered at the elevator controller 115.

In one or more embodiments of the disclosure, the control logic of the elevator controller 115 can receive an elevator call request from input 218 when the switch 212 is held in the actuated position which provides input 216. After the elevator car 103 is dispatched to service the elevator call request, the elevator controller 115 can automatically lock the elevator car 103 until the switch 212 is initiated again. In a different embodiment, the elevator controller 115 can remain unlocked for a period of time to receive multiple elevator call requests prior to locking the elevator car 103. It can be appreciated that the switch 212 can be any other type of mechanism that is coupled to the elevator controller 115.

FIG. 2C depicts another embodiment for managing elevator call requests. As shown, this embodiment does not include an unlock button 202 or an unlock switch 212 (of FIGS. 2A and 2B, respectively). In this embodiment, the control logic of the elevator controller 115 is configured with a pin code to unlock the elevator car 103. The pin code can include a predetermined sequence of button presses that may be initiated on the elevator call panel 224. The user can be informed of the pin code by placing a sign in the elevator car such as above the elevator call panel 224 or other location. In addition, the pin code can require simultaneous button presses or sequential button presses that can be identified by the elevator controller 115. For example, the inputs 226 and 228 can be required to be pressed simultaneously or in an ordered sequence. The control logic can identify the pattern and/or combination of inputs prior to unlocking the elevator and dispatching the elevator car 103. The patterns and sequence can make it challenging for an unauthorized person such as a child to unlock the elevator car 103.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

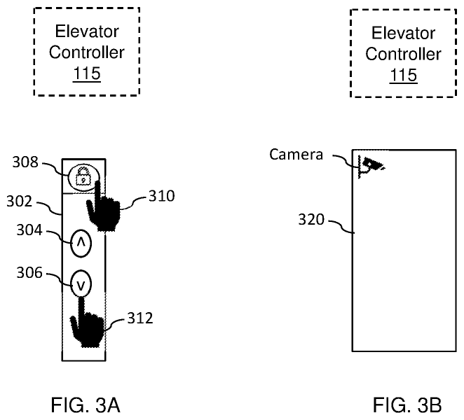

FIG. 3A depicts a hall call panel 302 used to call an elevator in accordance with one or more embodiments of the disclosure. The hall call panel 302 can include selections 304, 306 to receive inputs indicating the direction the passenger wishes to travel. The hall call panel 302 can be equipped with a hall call unlock button 308 (or locking mechanism (not shown) similar to that shown in FIG. 2A). In one instance, the unlock button 308 or locking mechanism can be located above the hall call panel 302. The location of the unlock button 308 can make it difficult for children to access the controls and place a nuisance call. In a different embodiment, the unlock button 308 or locking mechanism can be integrated into the hall call panel 302. The control logic for the elevator controller 115 can require an input from the unlock button 308 or locking mechanism and the selection to be actuated simultaneously to make a selection. If the control logic does not receive the appropriate input, the control logic will disregard the received inputs and maintain the elevator car in the locked position. In another embodiment, the selection may be made after sequentially providing the inputs 310 to the unlock button 308 and the input 312 on the selection for the direction 304, 306. In a different embodiment, the inputs can be provided sequentially.

The hall call panel 302 is generally accessible. The height of the hall call panels 302 is not regulated, and therefore, the hall call panels 302 or the unlock button 202 can be raised similar to the unlock button 202 of FIG. 2A. In one or more embodiments of the disclosure, the unlock button 308 is arranged above the hall call panel 302.

In an alternate embodiment, the control logic of the elevator controller 115 can be operably coupled to a sensor such as a camera (FIG. 3B) to manage the elevator locking control. For example, the control logic can use the input from the camera to determine whether a child or an adult is within proximity to the hall call panel shown in FIG. 3A or the hall call panel 302 located within the elevator car 103. Various image processing techniques can be used to analyze the features of the passengers. For example, the image processing techniques can be used machine learning techniques to identify the different heights that are associated with adults and children, the different facial features of the adult and the children can be analyzed, etc.

Responsive to identifying a child the elevator lock can remain engaged. Otherwise, if an adult is identified the elevator lock is disabled and the adult is able to register a hall call or an elevator call. It will be appreciated that other types of sensors can be envisioned to be within the scope of the disclosure and is not limited by the description provided in FIG. 3B.

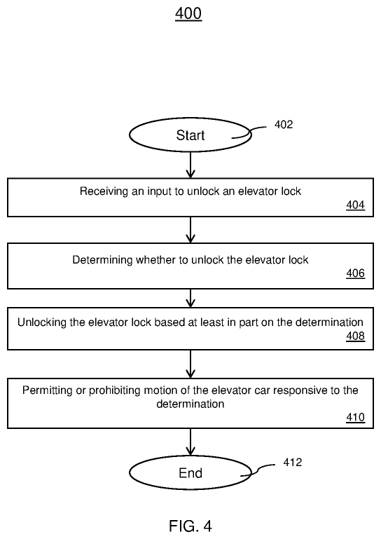

FIG. 4 depicts a flowchart of a method 400 for managing unwanted elevator calls in accordance with one or more embodiments of the disclosure. It should be understood that the method 400 can be performed in any of the systems shown in FIG. 1, 2, or 3. It can be appreciated that the method 400 can be performed in other systems. The method 400 begins at block 402, and proceeds to block 404 receives an input to unlock an elevator lock. The input can be received by a controller (i.e., elevator controller 115) or other type of device configured to communicate with an elevator system. The input can be received from a panel or a button or switch or other type of mechanism. Responsive to receiving the input, a signal is provided to the elevator controller 115.

Block 406 determines whether to unlock the elevator lock. The elevator controller 115 can compare the input to the predetermined input to disable the elevator lock. In an example, the elevator controller 115 can determine if the proper sequence of inputs is received from the elevator panel, or if the specific input is pressed for a sufficient period of time.

Block 408 unlocking the elevator lock based at least in part on the determination. Responsive to receiving the proper input, the elevator controller 115 can unlock the elevator car 103 to receive the elevator floor selection. Otherwise, the elevator car 103 remains locked and no elevator call requests can be registered in the elevator controller 115. Block 410 permits or prohibits motion of the elevator car responsive to the determination.

The method 400 ends at block 412. It should be appreciated that different steps or a different sequence of steps can be used and envisioned to be within the scope of the disclosure. One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

The technical effects and benefits of one or more embodiments of the disclosure provide a low-cost solution to enable and disable a child-safety feature to filter and reduce nuisance calls. The techniques of one or more embodiments described herein avoid the required for the installation of costly components such as sensors, RGB cameras, access cards, etc. The techniques described herein do not require extra mechanical hardware such as door jammers or other mechanical features.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method for filtering unintended requests, the method comprising:
receiving, by a device, an input to disable an elevator lock for an elevator car;
determining, by the device, whether to unlock the elevator lock;
unlocking, by the device, the elevator lock based at least in part on the determination; and
responsive to the determination, permitting or prohibiting motion of the elevator car.

2. The method of claim 1 further comprising filtering the input responsive to an incorrect input sequence from a panel.

3. The method of claim 1, further comprising:
responsive to unlocking the elevator lock, receiving an elevator call request indicating a floor selection for an elevator car; and
dispatching the elevator car based at least in part on the floor selection.

4. The method of claim 3 further comprising receiving the elevator call request within a period of time responsive to unlocking the elevator lock.

5. The method of claim 1, further comprising enabling the elevator lock responsive to at least one of an elevator lock input or an expiration of a configurable period of time.

6. The method of claim 1, wherein the input is received from a dedicated child-lock button, wherein the dedicated child-lock button is arranged above a panel for the elevator car.

7. The method of claim 1, wherein the input comprises a predetermined sequence of buttons.

8. The method of claim 1, wherein the input is received from an unlock mechanism, wherein the unlock mechanism is a switch.

9. The method of claim 1, wherein the input is depressed for a configurable threshold period of time.

10. The method of claim 1, further comprising providing an indication of the elevator car being unlocked.

11. A system for managing elevator call requests, the system comprising;
a controller to control an elevator car;
a panel coupled to the controller, wherein the panel is configured to provide an input to the controller, wherein the controller is configured to:
receive an input to unlock an elevator lock;
determine whether to unlock the elevator lock;
unlock the elevator lock based at least in part on the determination; and
responsive to the determination, permit or prohibit motion of the elevator car.

12. The system of claim 11, wherein the controller is configured to filter the input responsive to an incorrect input sequence from the panel.

13. The system of claim 11, wherein the controller is configured to:
receive an elevator call request indicating a floor selection for an elevator car responsive to unlocking the elevator lock; and
dispatch the elevator car based at least in part on the floor selection.

14. The system of claim 11, wherein the controller is configured to receive the elevator call request within a period of time responsive to unlocking the elevator lock.

15. The system of claim 11, wherein the controller is configured to enable the elevator lock responsive to at least one of an elevator lock input or an expiration of a configurable period of time.

16. The system of claim 11, wherein the input is received from a dedicated child-lock button, wherein the dedicated child-lock button is arranged above the panel for the elevator car.

17. The system of claim 11, wherein the input comprises a predetermined sequence of buttons.

18. The system of claim 11, wherein the input is received from a unlock mechanism, wherein the unlock mechanism is a switch.

19. The system of claim 11, wherein the input is depressed for a configurable threshold period of time.

20. The system of claim 11, wherein the controller is configured to provide an indication of the elevator being unlocked.
